(19) United States
(12) Patent Application Publication
(10) Pub. No.: US 2009/0259409 A1
(43) Pub. Date: Oct. 15, 2009

(54) Process for determining the green star rating of compounds and formulations

(76) Inventor: Anthony J. O'Lenick, JR., Dacula, GA (US)

Correspondence Address: ANTHONY J O'LENICK JR, 2170 LUKE EDWARDS ROAD, DACULA, GA, 30019, US

(21) Appl. No.: 12/157,730

(22) Filed: Jun. 13, 2008

Related U.S. Application Data
(60) Provisional application No. 61/123,879, filed on Apr. 12, 2008.

(51) Int. Cl. G06F 19/00

(52) U.S. Cl. 702/22

(57) ABSTRACT

The invention is directed toward a process that can be used in the formulation of more environmentally friendly, greener formulations for consumer applications. The process includes the evaluation of components in a formulation, then determining the percentage of the molecule that is green, establishing a green star rating and determining the effect of that component on the overall green star rating of a formulation.

### RELATED APPLICATIONS

This application claims priority to and benefit of U.S. Provisional Application No. 61/123,879 filed Apr. 12, 2008, the disclosure of which is incorporated herein for all purposes.

### FIELD OF THE INVENTION

The present invention is directed toward a process that can be used in the formulation of more environmentally friendly, greener formulations for consumer applications. The process includes the evaluation of components in a formulation, then determining the percentage of the molecule that is green, establishing a green star rating and determining the effect of that component on the overall green star rating of a formulation.

### BACKGROUND OF THE INVENTION

Today's consumer and formulator have become increasingly aware of the consumption of resources that are not renewable. Products derived from fossil fuels are nonrenewable. This includes products like Gasoline, coal, natural gas, diesel, and other commodities.

Green resources are defined as renewable resources, replenished by natural processes. Green products are renewable resources include oxygen, fresh water, timber, and biomass. Green products also include commodities such as wood, paper, and leather. Furthermore, alcohol, oils from plants and seeds are considered green products.

These green raw materials are the most environmentally friendly and their use are the most conservative in minimizing negative impact on the earth. However, these basic green products cannot be combined it a way that provides consumer products that meet the demands of the consumer. For example soap can be a green detergent, but it does not possess all the desirable properties that give the consumer a laundry detergent. In order to make high performance formulations, some materials that are not strictly speaking green are required.

While the concept of green products is straightforward, the ability for the formulator and the consumer to quantify the greenness of a given shampoo or other consumer product is elusive. Given a proper understanding, the consumer and formulator can make better informed better educated decisions as to making products with the best combination of green properties and formulation attributes. In other words, the need of the consumer and the need of the environment can be intelligently determined.

Prior to the present invention, the formulator and consumer lacked a process by which the “greenness” of a formulation and a raw material could be determined. This required either an all or noting approach to environmental stewardship. We recognized that the formulation of a consumer product with the optimum trade off in performance and greenness required a systematic approach to develop a measurable metric for the level of greenness in a formulation. This has resulted in the Green Star Rating system or simply GSR.

This process allows the formulation chemist a way to break a molecule down into green portion and a non-renewable resource portion. The evaluation of this data allows for the generation of a Green Star Value, which is the percentage of the molecule that is based upon green chemistry divided by 10. Once this number is known, the effect of replacing one ingredient in a formulation with a “greener” compound can be ascertained. Specifically, if a raw material used in a formulation at 20% by weight has a Green Star Rating of 1 is replaced with a product with a Green Star Rating of 7, the impact on the formulation is (7-1) times 0.20 or 1.2. This means that much more renewable resources are being used in the formulation and its consumption will impact less negatively on the environment. This approach allows the formulator to make greener product and the consumer to choose greener products. By greener products is meant products based upon a greater percentage of renewable resources. Greener products are those with a higher Green Star Rating.

### THE INVENTION

### Objective of the Invention

It is the objective of the invention to develop a process for determining the greenness of a raw material and formulation used by consumers. Greenness is defined as the percentage of a formulation and of a raw material based upon renewable resources. The ability to quantify the greenness in what is called the Green Product Rating (GPR) allows for a real number to be generated using the process of the present invention. That real number allows the formulator the chance to optimize the Green Star Value and the consumer to intelligently access the formulation for environmental impact.

### SUMMARY OF THE INVENTION

The present invention is directed toward a method for automatically obtaining a green star value, comprising:
(1) determining the empirical formula for chemical compounds used to make formulated products;
(2) determining which portions of the molecule are green;
(3) determining the percentage by weight of the green portion of the molecule
(4) determining the green star value and optionally
(5) optimizing the formulation by selecting components with the greatest green star value.

### DETAILED DESCRIPTION OF THE INVENTION

The Green Star Rating (GSR) is a classification system designed to allow the formulation chemist the ability to maximize the renewable component in products. The higher the Green Star Rating the more green the product.

### EXAMPLE 1

### Sodium Coco Alcohol Derived from Natural Alcohol

Step one—determining the empirical formula for chemical compounds used to make formulated product:

Example—Sodium Coco sulfate

C₁₂H₂₃SO₄Na

Step two—determining which portions of the molecule are green;

Example—Sodium coco sulfate
Renewable Material Natural Alcohol C₁₂H₂₃
Non-Renewable Synthetic Sulfation SO₄Na

Step three—determining the percentage by weight of the green portion of the molecule. This is done by multiplying the weight of each atom by the number of atoms of in each portion

### Renewable—Natural Alcohol C₁₂H₂₃

Carbon has a molecular weight of 12 there are 12 present in the renewable portion so the molecular weight contribution of the carbon is 12 times 12 or 144.

Hydrogen has a molecular weight of 1 there are 23 hydrogen atoms present in the renewable portion so the molecular weight contribution of the hydrogen is 1 times 23 or 23.

The sum of all the elements in the renewable portion is 144+23 or 167.

The Non-renewable portion is SO₄Na.

Sulfur has a molecular weight of 32 there is 1 sulfur atom present in the non-renewable portion so the molecular weight contribution of the sulfur is 1 times 32 or 32.

Oxygen has a molecular weight of 16 there are 4 oxygen atoms present in the non-renewable portion so the molecular weight contribution of the hydrogen is 4 times 16or 64.

Sodium has a molecular weight of 23 there is 1 sodium atom present in the non-renewable portion so the molecular weight contribution of the sulfur is 1 times 23 or 23.

The sum of all the elements in the non-renewable portion is 32+64+23=119

Total Molecular Weight=Renewable Portion+Non-Renewable portion

Total Molecular Weight=167+119=289

Renewable Portion/Total=167/289=57.7%

Step 4 Determining the Green Star Value

Green Star Value (GSV)=% Renewable rounded to unit=58

### EXAMPLE 2

### Sodium laureth 3 Sulfate

C₁₂H₂₃O(CH₂CH₂O)₃SO₃Na

C₁₈H₃₅O₇SNa Empirical Formula

| | | | |
|---|---|---|---|
| Renewable | C₁₂H₂₃ | Synthetic | —(CH₂CH₂O)₃SO₄Na |
| | Natural Alcohol | | EO-Sulfate |

Calculations

| | C | H | N | O | P | S | Na | K |
|---|---|---|---|---|---|---|---|---|
| Renewable Portion | | | | | | | | |
| Number | 12 | 23 | 0 | 0 | 0 | 0 | 0 | 0 |
| MW | 144 | 23 | 0 | 0 | 0 | 0 | 0 | 0 |
| Total | 167 | | | | | | | |
| Non- | | | | | | | | |
| Renewable | | | | | | | | |
| Number | 6 | 12 | 0 | 7 | 0 | 0 | 1 | 0 |
| MW | 72 | 12 | 0 | 112 | 0 | 0 | 23 | 0 |
| Total | 219 | | | | | | | |
| Total | 386 | | | | | | | |
| % | 43 | | | | | | | |
| Renewable | | | | | | | | |
| Green Star Rating | 43 | | | | | | | |

### EXAMPLE 3

### Sodium Lauryl Sulfate (Ziegler Alcohol Derived)

Example—Sodium lauryl sulfate

C₁₂H₂₃SO₄Na

Step two—determine which parts of the molecule are natural (derived from green natural raw materials) and which are synthetic.

Example—Sodium lauryl sulfate
Synthetic C₁₂H₂₃SO₄Na

Step three

| | C | H | N | O | P | S | Na |
|---|---|---|---|---|---|---|---|
| Renewable Portion | | | | | | | |
| Number | 0 | 0 | 0 | 0 | 0 | 0 | 0 |
| MW | 0 | 0 | 0 | 0 | 0 | 0 | 0 |
| Total | 0 | | | | | | |
| Non- | | | | | | | |
| renewable | | | | | | | |
| Number | 12 | 23 | 0 | 4 | 0 | 1 | 1 |
| MW | 144 | 23 | 0 | 64 | 0 | 31 | 23 |
| Total | 285 | | | | | | |
| Total | 285 | | | | | | |
| % Renewable | 0 | | | | | | |
| Green Star Rating | 0 | | | | | | |

### EXAMPLE 4

### Cocamidopropyl Betaine

### Structure

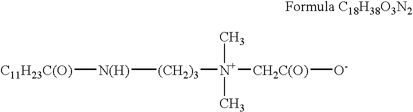

Step two—determine which parts of the molecule are natural (derived from green natural raw materials) and which are synthetic.
Renewable C₁₂H₂₃O Nonrenewable C₆H₁₄O₂N₂

Step three

| | C | H | N | O | P | S | Na | K |
|---|---|---|---|---|---|---|---|---|
| Renewable | | | | | | | | |
| Portion | | | | | | | | |
| Number | 12 | 23 | 0 | 1 | 0 | 0 | 0 | 0 |
| MW | 144 | 23 | 0 | 16 | 0 | 0 | 0 | 0 |
| Total | 183 | | | | | | | |
| Non- | | | | | | | | |
| Renewable | | | | | | | | |
| Number | 6 | 14 | 2 | 2 | 0 | 0 | 0 | 0 |
| MW | 72 | 14 | 28 | 32 | 0 | 0 | 0 | 0 |
| Total | 146 | | | | | | | |
| Total | 329 | | | | | | | |
| % | 55.6 | | | | | | | |
| Renewable | | | | | | | | |
| Green Star | 56 | | | | | | | |
| Rating | | | | | | | | |

### EXAMPLE 5

### Cocamid DEA

### Structure C₁₁H₂₃—C(O)—N—(CH₂CH₂OH)₂

C₁₆H₃₀O₃N

Step two—determine which parts of the molecule are natural (derived from green natural raw materials) and which are synthetic.

C₁₁H₂₃—C(O)—N—(CH₂CH₂OH)₂
Renewable C₁₂H₂₃O Non-renewable C₄H₁₀O₂N

Step three

| | C | H | N | O | P | S | Na | K |
|---|---|---|---|---|---|---|---|---|
| Number | 12 | 23 | 0 | 1 | 0 | 0 | 0 | 0 |
| MW | 144 | 23 | 0 | 16 | 0 | 0 | 0 | 0 |
| Total | 183 | | | | | | | |
| Synthetic | | | | | | | | |
| Number | 4 | 10 | 1 | 2 | 0 | 0 | 0 | 0 |
| MW | 48 | 10 | 14 | 32 | 0 | 0 | 0 | 0 |
| Total | 104 | | | | | | | |
| Total | 287 | | | | | | | |
| % | 63 | | | | | | | |
| renewable | | | | | | | | |
| Green Star Rating | 63 | | | | | | | |

### EXAMPLE 6

### Cocamid MEA

### Structure C₁₁H₂₃—C(O)—NH—CH₂CH₂OH

C₁₄H₂₉O₂N

Step two—determine which parts of the molecule are natural (derived from green natural raw materials) and which are synthetic.

C₁₁H₂₃—C(O)—NHCH₂CH₂OH
Renewable C₁₂H₂₃O Non-renewable C₂H₆ON

Step three

| | C | H | N | O | P | S | Na | K |
|---|---|---|---|---|---|---|---|---|
| Renewable Portion | | | | | | | | |
| Number | 12 | 23 | 0 | 1 | 0 | 0 | 0 | 0 |
| MW | 144 | 23 | 0 | 16 | 0 | 0 | 0 | 0 |
| Total | 183 | | | | | | | |
| Non- | | | | | | | | |
| Renewable | | | | | | | | |
| Number | 2 | 6 | 1 | 2 | 0 | 0 | 0 | 0 |
| MW | 24 | 6 | 14 | 32 | 0 | 0 | 0 | 0 |
| Total | 76 | | | | | | | |
| Total | 259 | | | | | | | |
| % Renewable | 70.6 | | | | | | | |
| Green Star Rating | 71 | | | | | | | |

Formulations

The process used in the present invention can be used on any formulation.

Conditioning Shampoo

| | % weight |
|---|---|
| Water | 55.0 |
| Sodium Lauryl Sulfate | 18.0 |
| Sodium Laureth 3 Sulfate | 16.0 |
| Cocamidopropyl Betaine | 8.0 |
| Cocamid DEA | 3.0 |

### EXAMPLE 7

Conditioning Shampoo

This product is based on sodium lauryl sulfate (synthetic alcohol)

| | % weight | % Solids | Example | GRS | Contribution |
|---|---|---|---|---|---|
| Water | 55.0 | — | — | — | — |
| Sodium lauryl Sulfate | 34.0 | 9.5 | Example 3 | 0 | 0 (.095 times 0) |
| Cocamidopropyl Betaine | 8.0 | 2.8 | Example 4 | 56 | 1.6 (.028 times 56) |
| Cocamid MEA | 3.0 | 3.0 | Example 6 | 71 | 2.1 (.03 times 71) |

| | |
|---|---|
| Total | 3.7 |

### EXAMPLE 8

Conditioning Shampoo (Version 1)

This product is based on sodium lauryl sulfate (synthetic alcohol) and SLES-3

| | % weight | % Solids | Example | GRS | Contribution |
|---|---|---|---|---|---|
| Water | 55.0 | — | — | | — |
| Sodium Lauryl Sulfate | 17.0 | 4.5 | Example 3 | 0 | 0 (.045 times 0) |
| Sodium Laureth 3 Sulfate | 17.0 | 4.5 | Example 2 | 43 | 2.0 (.045 times 43) |
| Cocamidopropyl Betaine | 8.0 | 2.8 | Example 4 | 56 | 1.6 (.028 times 56) |
| Cocamid DEA | 3.0 | 3.0 | Example 5 | 63 | 1.9 (.03 times 63) |

| | |
|---|---|
| Total | 5.5 |

### EXAMPLE 9

Conditioning Shampoo

This product is based on sodium coco sulfate (renewable alcohol)

| | % weight | % Solids | Example | GRS | Contribution |
|---|---|---|---|---|---|
| Water | 55.0 | — | — | — | — |
| Sodium Coco Sulfate | 17.0 | 4.5 | Example 1 | 58 | 2.6 (.045 times 58) |
| Sodium Laureth 3 Sulfate | 17.0 | 4.5 | Example 2 | 43 | 1.9 (.045 times 43) |
| Cocamidopropyl Betaine | 8.0 | 2.8 | Example 4 | 56 | 1.6 (.028 times 56) |
| Cocamid DEA | 3.0 | 3.0 | Example 5 | 63 | 1.9 (.03 times 63) |

| | |
|---|---|
| Total | 8.0 |

### EXAMPLE 10

Conditioning Shampoo

This product is based on sodium coco sulfate (renewable alcohol)

| | % weight | % Solids | Example | GRS | Contribution |
|---|---|---|---|---|---|
| Water | 55.0 | — | — | — | — |
| Sodium Coco Sulfate | 17.0 | 4.5 | Example 1 | 58 | 2.6 (.045 times 58) |
| Sodium Laureth 3 Sulfate | 17.0 | 4.5 | Example 2 | 43 | 1.9 (.045 times 43) |
| Cocamidopropyl Betaine | 8.0 | 2.8 | Example 4 | 56 | 1.6 (.028 times 56) |
| Cocamid MEA | 3.0 | 3.0 | Example 6 | 71 | 2.1 (.03 times 71) |

| | |
|---|---|
| Total | 8.2 |

The simple formulations above show the power of the new system. Minor changes in the formulation made be properly selecting raw materials result in a 2.2 times improvement in the green star rating. This process allows the formulator to fine tune formulations to maximize greenness and to inform the consumer about the degree amount of a given formulation that is renewable. The same approach works not only on shampoos but all formulations.

| Example | Green Star Rating |
|---|---|
| 7 | 3.7 |
| 8 | 5.5 |
| 9 | 8.0 |
| 10 | 8.2 |

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth hereinabove but rather that the claims be construed as encompassing all the features of patentable novelty which reside in the present invention, including all features which would be treated as equivalents thereof by those skilled in the art to which the invention pertains.

What is claimed:

1. A method for automatically obtaining a green star value, comprising:
a. determining the empirical formula for all the chemical compounds used to make formulated products;
b. determining which portions of the molecule are green;
c. determining the percentage by weight of the green portion of the molecule
d. determining the green star value.
and optionally;
e. optimizing the formulation by selecting components with the greatest green star value.

2. A method for automatically obtaining a green star value, for a cosmetic formulation comprising:
A. determining the empirical formula for all the chemical compounds used to make formulated products;
B. determining which portions of the molecule are green;
C. determining the percentage by weight of the green portion of the molecule
D. determining the green star value.
and optionally;
E. optimizing the formulation by selecting components with the greatest green star value.
